(19) United States
(12) Patent Application Publication
(10) Pub. No.: US 2003/0164007 A1
(43) Pub. Date: Sep. 4, 2003

(54) Method for collapsing a hollow substrate tube into a rod-like preform while heating

(75) Inventors: Dennis Robert Simons, Eindhoven (NL); Igor Milicevic, Aarle-Rixtel (NL)

Correspondence Address: OBLON, SPIVAK, MCCLELLAND, MAIER & NEUSTADT, P.C., 1940 DUKE STREET, ALEXANDRIA, VA, 22314, US

(73) Assignee: DRAKA FIBRE TECHNOLOGY B.V., Eindhoven (NL)

(21) Appl. No.: 10/328,005

(22) Filed: Dec. 26, 2002

(30) Foreign Application Priority Data
Dec. 28, 2001 (NL) 1019675

(51) Int. Cl. C03B 37/012

(52) U.S. Cl. 65/428; 65/429

(57) ABSTRACT

The present invention relates to a method for collapsing a hollow substrate tube into a rod-like preform while heating by reciprocating a heating element along the length of the substrate tube. The present invention is characterized in that a constant electric power is supplied to the heating element during collapsing.

The present invention relates to a method for collapsing a hollow substrate tube into a rod-like preform while heating by reciprocating a heating element along the length of the substrate tube.

Such a method is known per se from Dutch patent No 1012616 (corresponding to International patent application WO 01/05721) granted to the present applicant, whose contents may be considered to be incorporated herein. According to the method that is known therefrom, a preform for an optical fibre is manufactured by depositing one or more glass layers, which may or may not be doped, on the internal surface of a hollow quartz glass support or substrate tube, in which a furnace is moved axially with respect to the support tube, and after the glass layers have been deposited the support tube is collapsed into a rod-like preform while being heated. The contraction or collapsing process takes place at a temperature above the softening temperature, generally at a temperature of about 2000° C. Since the hollow substrate tube is contracted into a rod-like preform in the course of a number of passages of the heating element, a proper control of the temperature used and of the speed of movement of the heating element are essential. In practice it has become apparent, however, that the temperature control, which usually consists of keeping the temperature at a constant level during a passage of the heating element, with the temperature measurement being carried out by means of a pyrometer, is not reproducible to a sufficient degree. The consequence of such a shortcoming is that the diameter of the rod-like preform is not constant along the length thereof. In addition, substrate tubes having mutually different diameters are obtained. The aforesaid Dutch patent merely states that the temperature of the furnace is set at a level between the softening temperature, viz. a viscosity of 10^{6.65} Pa.s, and the melting temperature, viz. a viscosity of 10¹ Pa.s, with the combination of the furnace temperature and axial movement of the furnace providing the conditions required for contraction. No information with regard to the process control of the furnace can be derived from the aforesaid document.

The object of the present invention is to provide a method for collapsing a hollow substrate tube into a rod-like preform while heating, in which the differences in diameter in the preform that has been contracted into a rod-like element are minimised.

Another object of the present invention is to provide a method for collapsing a hollow substrate tube into a rod-like preform while heating, in which the closing of the hollow substrate tube takes place as gradually as possible, so that the full length of the preform that has been contracted into a rod-like element is suitable for drawing an optical fibre therefrom.

The invention as referred to in the introduction is characterized in that a constant electric power is supplied to the heating element during collapsing.

The supplying of a constant electric power to the heating element during the contraction or collapse process leads to a stable process. With the present method, factors that were previously considered as interfering influences, such as ageing of the heating element and surface conditions of the substrate tube, have hardly any influence on the contraction process, if at all. Any scratches and/or the presence of bubbles in the substrate tube made from quartz glass, which generally cause the temperature measurement to be non-reproducible, do not have an adverse effect on the present contraction process, because a constant electric power is supplied to the substrate tube during the contraction process at all times, which electric power does not depend on the measured temperature at a particular location, for example the external surface of the substrate tube, or the heating element. Thus the present invention is not sensitive to factors which stand in the way of a correct, reproducible temperature measurement.

The present invention is further characterized in that an electrical resistance furnace is used as the heating element.

An electrical resistance furnace is desired in particular in order to minimise the incorporation of OH impurities, which impurities especially occur when gas burners are used. Such OH impurities may diffuse in the direction of the core as a result of further processing steps being carried out at high temperatures, which OH impurities will lead to adverse effects in the light conducting part of the optical fibre. After all, the OH groups exhibit a wide absorption peak at 1385 nm, resulting in additional loss of signal in the optical fibre at the currently usual transmission wavelength of around 1300 nm.

The use of a constant electric power is in particular favourable in the case of contraction processes of substrate tubes whose internal surface comprises dopant in an amount of at least 4 mol. %. Such amounts of dopant appeared to exhibit a very high infrared absorption level, so that the previously used temperature measurement carried out by means of a pyrometer resulted in large differences in the measured values, which temperature measurement determined the output of the heating element in such a situation. Since the present method maintains the output of the heating element at a constant level during the contraction process, also substrate tubes containing large amounts of dopants can be formed into massive rod-like preforms in a reproducible manner.

The present invention is in particular suitable for being used in the method as known from U.S. Pat. No. 4,793,843 in the name of the present applicant, which document can be considered to be fully incorporated herein. According to the method that is known therefrom, a etching gas consisting of C2F6 and oxygen is passed through the internal cavity or duct that is still present while the hollow substrate tube is closing, which closing is preferably carried out in accordance with the present invention, in particular by supplying a constant electric power to the heating element. The constant supply of electric power leads to a stable process, which prevents disturbance of the refractive index profile of the final optical fibre, which disturbance is ascribed to the undesirable diffusion of dopants from layers situated further away from the core, or to insufficient local etching off of deposited layers, seen along the length of the substrate tube. Consequently it is preferred not only to realise special process conditions during the closing of the hollow substrate tube, but in particular also to pass an etching gas through the central opening of the hollow substrate tube, with a constant electric power being supplied to the heating element, just before the duct closes spontaneously to form a rod-like preform.

It should be understood that the present invention is not limited to the contraction process, but that it is also possible to narrow quartz glass tubes by using the present method, that is, to effect a diameter reduction while lengthening an already contracted rod-like preform, which preform thus obtained is suitable for being placed in a jacket having a standard diameter.

1. A method for collapsing a hollow substrate tube into a rod-like preform while heating by reciprocating a heating element along the length of the substrate tube, characterized in that a constant electric power is supplied to the heating element during collapsing.

2. A method according to claim 1, characterized in that an electrical resistance furnace is used as the heating element.

3. A method according to any one of the preceding claims, characterized in that the internal surface of the substrate tube comprises dopant in an amount of at least 4 mol. %.

4. A method for collapsing a hollow substrate tube into a rod-like preform while heating by reciprocating a heating element along the length of the substrate tube, characterized in that an etching gas is passed through the central opening of the hollow substrate tube, with a constant electric power being supplied to the heating element, just before the duct closes spontaneously to form a rod-like preform.
